(19) United States
(12) Patent Application Publication
(10) Pub. No.: US 2026/0361998 A1
(43) Pub. Date: Nov. 12, 2026

(54) Dynamic Power Optimization for Image Signal Processing

(71) Applicants: Advanced Micro Devices, Inc, Santa Clara, CA (US); ATI Technologies ULC, Markham (CA)

(72) Inventors: Wilson H. Yu, Markham (CA); Benjamin Koon Pan Chan, Markham (CA); Jin Li, Shanghai (CN); ManZhou Fang, Shanghai (CN); Wei Li, Shanghai (CN); William Lloyd Atkinson, Aurora (CA); Sebastien J Nussbaum, Lexington, MA (US)

(73) Assignees: Advanced Micro Devices, Inc, Santa Clara, CA (US); ATI Technologies ULC, Markham (CA)

(21) Appl. No.: 19/202,115

(22) Filed: May 8, 2025

(51) Int. Cl. H04N 23/65

(52) U.S. Cl. CPC H04N 23/651

(57) ABSTRACT

Dynamic power optimization for image signal processing is described. In one or more implementations, a device implementing the described optimization includes a battery, an image sensor configured to output image signals, an image signal processor coupled to the image sensor and configured to process the image signals, and a processor coupled to the image signal processor. The processor is configured to cause an adjustment of a frequency at which the image signal processor processes the image signals based on a power state of the battery. The processor may also selectively enable or disable one or more image transformations of the image signal processor based on the determined power state of the battery.

### BACKGROUND

Mobile devices face power consumption challenges when streaming images, such as during video conferencing, while operating on battery power. Continuous video capture keeps an image sensor and image signal processor active for extended periods, leading to substantial energy drain. Real-time encoding and compression of video data, often at high resolutions and frame rates, further increase processing demands, particularly when applying enhancements like noise reduction, background blurring, or AI-driven image adjustments. Transmitting the video stream over a wireless connection, whether via Wi-Fi or cellular networks, adds another layer of power-intensive activity, as network radios must remain active to maintain a stable connection. Simultaneously, displaying the video on a high-resolution screen and processing incoming video streams compound the power consumption. These factors collectively reduce battery life, leading to potential overheating, performance degradation, and shortened usability.

### BRIEF DESCRIPTION OF THE DRAWINGS

FIG. 1 is a block diagram of a processing system configured to execute one or more applications, in accordance with one or more implementations.

FIG. 2 is a block diagram of a non-limiting example in which a system provides dynamic power optimization for image signal processing.

FIG. 3 is a block diagram of a non-limiting example in which a system provides dynamic power optimization for image signal processing for use with a vehicle.

FIG. 4 depicts a procedure in an example implementation of dynamic power optimization for image signal processing.

### DETAILED DESCRIPTION

Conventional image signal processing systems in battery-powered devices often struggle to balance power consumption with image quality. These systems typically apply a fixed set of image transformations at a constant frame rate, regardless of the device's power state. This approach can rapidly deplete battery life during power-intensive tasks like video conferencing or continuous image capture for automotive applications. Additionally, traditional systems lack the flexibility to adapt processing parameters based on real-time changes in battery charge levels or specific use case requirements.

The approach described herein dynamically optimizes image signal processing based on a device's power state. In one or more implementations, a system leveraging this optimization includes a battery, an image sensor that outputs image signals, an image signal processor (ISP) coupled to the image sensor, and a processor coupled to the ISP. The processor adjusts the frequency at which the ISP processes image signals based on a power state of the device, e.g., a battery charge level of the battery providing power to the device. For example, the frequency at which the ISP processes the image signals can be adjusted by reducing the frequency to conserve battery power when the battery charge level of the battery is low, e.g., below a threshold. Doing so allows the system to conserve battery power when battery charge levels are low while still maintaining essential image processing capabilities. For instance, when the battery charge level drops below a threshold (e.g., 20% battery charge level), the processor may reduce the ISP processing frequency. This adjustment can substantially extend battery life during power-intensive tasks like video conferencing.

In one or more implementations, the processor can selectively enable or disable specific image transformations applied by the ISP to the image signals output by the image sensor. This selective approach ensures that critical image transformations, such as basic color correction, auto white balance, and/or auto exposure, are maintained while less essential processes may be disabled to conserve power. The system can dynamically adjust its processing parameters in response to real-time changes in battery charge levels by prioritizing certain image transformations as needed to conserve the battery. For example, during a video call when battery charge levels are low, the system may maintain basic color correction, auto white balance, and auto exposure, while disabling more computationally intensive transformations like advanced noise reduction. In a mobile photography scenario, the system could apply minimal transformations during image preview to save power, then temporarily enable full processing capabilities when capturing a still image. In an automotive application, the system may adjust its image processing based on factors such as vehicle speed or detected objects, balancing power consumption with the requirements of autonomous driving operations.

This dynamic approach offers several advantages over conventional systems. For example, the approach significantly extends battery life during power-intensive tasks like video conferencing, allowing users to participate in longer meetings without access to external power sources. The system's ability to adapt to real-time changes in power state and use case requirements ensures optimal performance across various scenarios. In automotive applications, this flexibility can improve overall system efficiency and potentially reduce hardware costs. By intelligently managing power consumption without significantly compromising image quality, this approach enhances user experience and device functionality in battery-powered imaging applications.

In some aspects, the techniques described herein relate to a computing device including: an image signal processor configured to process image signals received from an image sensor, and a processor coupled to the image signal processor, the processor configured to cause an adjustment of a frequency at which the image signal processor processes the image signals based on a power state of the computing device.

In some aspects, the techniques described herein relate to a computing device, wherein the processor is further configured to control the image signal processor to selectively apply image transformations to the image signals based on the power state of the computing device.

In some aspects, the techniques described herein relate to a computing device, wherein the power state of the computing device is based on a battery charge level of a battery of the computing device.

In some aspects, the techniques described herein relate to a computing device, wherein the processor is further configured to dynamically adjust the frequency and the image transformations applied by the image signal processor based on real-time changes to the battery charge level of the battery.

In some aspects, the techniques described herein relate to a computing device, wherein the processor is configured to control the image signal processor to selectively apply the image transformations by selectively enabling or disabling the image transformations applied to the image signals.

In some aspects, the techniques described herein relate to a computing device, wherein the image transformations selectively enabled include at least one of basic color correction, auto white balance, auto exposure, focus, noise reduction, black level lighting, demosaicing, contrast gamma value adjustment, or image sharpening.

In some aspects, the techniques described herein relate to a computing device, wherein the image transformations selectively disabled include at least one of basic color correction, auto white balance, auto exposure, focus, noise reduction, black level lighting, demosaicing, contrast gamma value adjustment, or image sharpening.

In some aspects, the techniques described herein relate to a computing device, wherein the processor is configured to cause a reduction of the frequency at which the image signal processor operates to conserve battery power, responsive to a battery charge level of a battery being below a threshold.

In some aspects, the techniques described herein relate to a computing device, wherein the power state of the computing device is determined based on one or more of: a battery charge level of a battery of the computing device, a power source connection status, or a user-selected power mode.

In some aspects, the techniques described herein relate to a computing device, wherein the processor is further configured to cause the adjustment of the frequency at which the image signal processor processes the image signals based on an application for which video data produced by the image signal processor is used.

In some aspects, the techniques described herein relate to a computing device, wherein the image signal processor includes multiple processing blocks, each processing block configured to apply one or more image transformations, and wherein the processor is configured to selectively enable or disable each of the multiple processing blocks based on the power state of the computing device.

In some aspects, the techniques described herein relate to a computing device, wherein the computing device includes a laptop.

In some aspects, the techniques described herein relate to a computer-implemented method including: producing, by an image sensor of a device, an image signal based on capturing light of a scene, causing, by a processor of the device and based on a power state of a battery configured to power the device, adjustment of a frequency at which an image signal processor processes the image signal to produce frames of video data, selectively enabling or disabling, by the processor, image transformations of the image signal processor based on the power state of the battery, and receiving, by the image signal processor, the image signal from the image sensor and processing the image signal to produce frames of video data with the enabled image transformations at the frequency.

In some aspects, the techniques described herein relate to a computer-implemented method, wherein the power state of the battery corresponds to a battery charge level of the battery.

In some aspects, the techniques described herein relate to a computer-implemented method, wherein causing the adjustment of the frequency at which the image signal processor processes the image signal includes reducing the frequency when the battery charge level of the battery is below a threshold.

In some aspects, the techniques described herein relate to a computer-implemented method, wherein the selectively enabling or disabling the image transformation further includes disabling one or more image transformations when the battery charge level of the battery is below a threshold.

In some aspects, the techniques described herein relate to a system including: a battery, an image sensor configured to output image signals, and an image signal processor coupled to the image sensor and configured to process the image signals based on a power state of the battery.

In some aspects, the techniques described herein relate to a system, wherein: the system includes a vehicle and the vehicle further includes an electronic control unit, the image signal processor is further configured to output video data based on processing the image signals, and the electronic control unit is configured to interface with one or more subsystems of the vehicle to control operation of the vehicle based on the video data.

In some aspects, the techniques described herein relate to a system, wherein the image signal processor is further configured to process the image signals at a frequency based on the operation of the vehicle.

In some aspects, the techniques described herein relate to a system, wherein the frequency is higher while the vehicle is in motion and the frequency is lower while the vehicle is stationary.

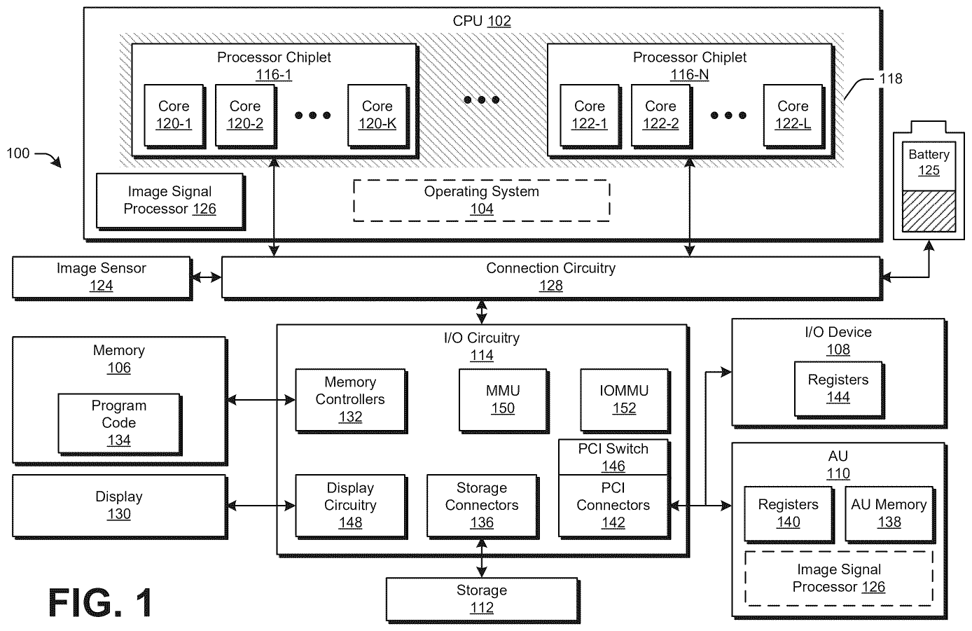

FIG. 1 is a block diagram of a processing system configured to execute one or more applications, in accordance with one or more implementations.

FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system 104 that manages the execution of applications. For example, the operating system 104 is configured to schedule the execution of tasks (e.g., instructions) for applications, allocate portions of resources (e.g., system memory 106, CPU 102, input/output (I/O) device 108, accelerator unit (AU) 110, storage 112, I/O circuitry 114) for the execution of tasks for the applications, provide an interface to I/O devices (e.g., I/O device 108) for the applications, or any combination thereof.

The CPU 102 includes one or more processor chiplets 116, which are communicatively coupled together by a data fabric 118 in one or more implementations.

Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

In accordance with the described techniques, the illustrated example includes an image sensor 124, battery 125, and image signal processor 126. In this example, the image sensor 124 is depicted connected to connection circuitry 128, and the image signal processor 126 is depicted being integrated within the CPU 102. In at least one implementation, the image sensor 124 is connected directly to the image signal processor 126. Alternatively, or additionally, an image signal processor 126 is included in and/or is implemented by the AU 110—as indicated by the image signal processor 126 with the dashed line in the AU 110. In variations, the image signal processor 126 is included in and/or is implemented by one or more different components of the processing system 100, such as a different type of system on chip, the I/O device 108, and so forth. In one or more implementations, the described techniques are utilized when a computing device, such as a computing device comprising the processing system 100, is unplugged and instead runs on power from the battery 125. As discussed above and below, the described techniques reduce power consumption and extend battery life, so that the computing device can be used for longer periods of time even while handling imaging intensive applications like video conferencing.

Additionally, within the processing system 100, the CPU 102 is communicatively coupled to an I/O circuitry 114 by the connection circuitry 128. For example, each processor chiplet 116 of the CPU 102 is communicatively coupled to the I/O circuitry 114 by the connection circuitry 128. The connection circuitry 128 includes, for example, one or more data fabrics, buses, buffers, queues, and the like. The I/O circuitry 114 is configured to facilitate communications between two or more components of the processing system 100 such as between the CPU 102, system memory 106, display 130, universal serial bus (USB) devices, peripheral component interconnect (PCI) devices (e.g., I/O device 108, AU 110), storage 112, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 114 includes one or more memory controllers 132. These memory controllers 132, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 132 are configured to manage access to the data stored at one or more memory addresses within the system memory 106, such as by CPU 102, the I/O device 108, and/or the AU 110.

When an application is to be executed by processing system 100, the operating system 104 running on the CPU 102 is configured to load at least a portion of program code 134 (e.g., an executable file) associated with the application from, for example, a storage 112 into system memory 106. This storage 112, for example, includes a non-volatile storage such as a flash memory, solid-state memory, hard disk, optical disc, or the like configured to store program code 134 for one or more applications.

To facilitate communication between the storage 112 and other components of processing system 100, the I/O circuitry 114 includes one or more storage connectors 136 (e.g., universal serial bus (USB) connectors, serial AT attachment (SATA) connectors, PCI Express (PCIe) connectors) configured to communicatively couple storage 112 to the I/O circuitry 114 such that I/O circuitry 114 is capable of routing signals to and from the storage 112 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 138. This AU memory 138, for example, includes any combination of one or more volatile memories and/or non-volatile memories, examples of which include caches, video RAM (VRAM), or the like. In one or more implementations, these compute units are also configured to execute these threads based on the data stored in one or more physical registers 140 of the AU 110.

To facilitate communication between the AU 110 and one or more other components of processing system 100, the I/O circuitry 114 includes or is otherwise connected to one or more connectors, such as PCI connectors 142 (e.g., PCIe connectors) each including circuitry configured to communicatively couple the AU 110 to the I/O circuitry such that the I/O circuitry 114 is capable of routing signals to and from the AU 110 to one or more other components of the processing system 100. Further, the PCIe connectors 142 are configured to communicatively couple the I/O device 108 to the I/O circuitry 114 such that the I/O circuitry 114 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 144 of the I/O device 108. In one or more implementations, such physical registers 144 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 142, and one or more other components of the processing system 100, the I/O circuitry 114 includes PCI switch 146. The PCI switch 146, for example, includes circuitry configured to route packets to and from the components of the processing system 100 connected to the PCI connectors 142 as well as to the other components of the processing system 100. As an example, based on address data indicated in a packet received from a first component (e.g., CPU 102), the PCI switch 146 routes the packet to a corresponding component (e.g., AU 110) connected to the PCI connectors 142.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 112, displays the scene on the display 130, or both. The display 130, for example, includes a cathode-ray tube (CRT) display, liquid crystal display (LCD), light emitting diode (LED) display, organic light emitting diode (OLED) display, or any combination thereof. To enable the processing system 100 to display a scene on the display 130, the I/O circuitry 114 includes display circuitry 148. The display circuitry 148, for example, includes high-definition multimedia interface (HDMI) connectors, DisplayPort connectors, digital visual interface (DVI) connectors, USB connectors, and the like, each including circuitry configured to communicatively couple the display 130 to the I/O circuitry 114. Additionally or alternatively, the display circuitry 148 includes circuitry configured to manage the display of one or more scenes on the display 130 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 114 includes memory management unit (MMU) 146 and input-output memory management unit (IOMMU) 148. The MMU 150 includes, for example, circuitry configured to manage memory requests, such as from the CPU 102 to the system memory 106. For example, the MMU 150 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 150 is configured to translate the virtual address indicated in the memory request to a physical address in the system memory 106 and to fulfill the request. The IOMMU 152 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 144 of the I/O device 108, the registers 140 of the AU 110, and/or the AU memory 138, the CPU 102 issues one or more MMIO requests. Such MMIO requests each request access to read, write, fetch, or pre-fetch data residing at one or more virtual addresses (e.g., guest virtual addresses) which each represent at least a portion of the registers 144 of the I/O device 108, the registers 140 of the AU 110, or the AU memory 138, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 152 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The processing system 100 is configurable in a variety of ways with different combinations of components in accordance with the described techniques.

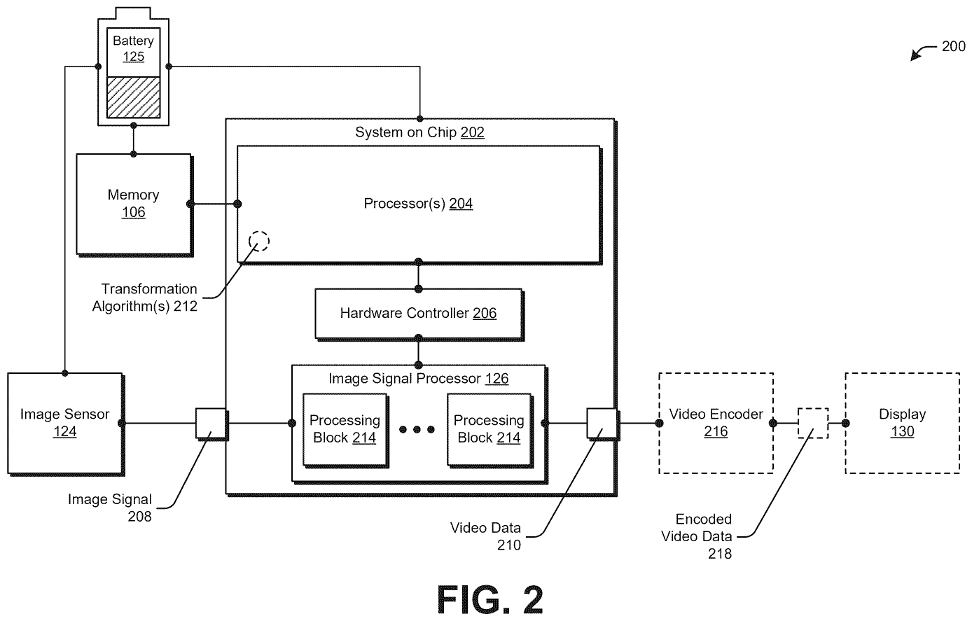

FIG. 2 is a block diagram of a non-limiting example 200 in which a system provides dynamic power optimization for image signal processing.

The illustrated example includes the system memory 106, the image sensor 124, and the image signal processor 126. The illustrated example also includes a system on chip 202, examples of which include but are not limited to the CPU 102, the AU 110, and other processors capable of controlling operation of the image signal processor 126. In this example, the image signal processor 126 is integrated on the system on chip 202. In at least on variation, though, the image signal processor 126 is external to the system on chip 202, and the system on chip 202 controls operation of the image signal processor 126 externally.

The illustrated system also includes the battery 125. In one or more implementations, the described techniques for dynamic power optimization for image signal processing are invoked when a device (e.g., a computing device having the system or a similar system) runs on power from the battery 125. Although the described optimization reduces power consumption thereby extending battery life of a computing device, the tradeoff for the reduced consumption is reduced quality video output by the image signal processor 126. While the tradeoff may be acceptable in exchange for the benefit of extending battery life, such reduced quality video may not be desirable when sufficient resources (e.g., power) are available for operating the computing device, such as when plugged in to an alternating current (AC) source. Thus, in one or more implementations, while a device receives power from an external source, the techniques discussed herein for dynamic power optimization for image signal processing are suspended. In at least one variation, the described optimization techniques are used while a device is connected to an external power source and is not reliant solely on battery power, such as to use the techniques for the purpose of being energy efficient.

In accordance with the described techniques, processor(s) 204 and/or the hardware controller 206 of the system on chip 202 are included in a control path of the system to the image signal processor 126. By contrast, the image sensor 124 is included in a data path to the image signal processor 126. In other words, the system on chip 202 is configured to control operation of the image signal processor 126, such as by using command signals, and the image sensor 124 is configured to provide data for processing to the image signal processor 126.

Broadly, the image sensor 124 captures or otherwise senses light of an environment (e.g., a scene) and produces an image signal 208 based on the sensed light. By way of example, the image sensor 124 produces an analog image signal. In one or more implementations, the image signal 208 is raw image data including, for instance, unprocessed or minimally processed data from the image sensor 124. The image sensor 124 outputs the image signal 208, and the image signal processor 126 receives the image signal 208 (e.g., directly) from the image sensor 124.

The image signal processor 126 processes the image signal 208. In one or more implementations, the image signal processor 126 is configured to process the image signal 208, at least in part, by applying one or more transformations to the image signal 208 to produce video data 210, an example of which is an ordered series of frames of image data. If the image signal 208 of a captured scene were merely converted to a format for output (e.g., via a display) without such transformations, the resulting output would look unlike the scene as humans see it with their eyes. To this end, image signals without such transformations may be of minimal use, if any, for applications where users expect images or video to look like what they would see, e.g., video conferencing, preview of a scene a camera would capture if a capture button were selected, and so on.

In at least one implementation, the transformations applied to the image signal 208 by the image signal processor 126 are implemented based on one or more transformation algorithms 212. Example transformations that can be applied by the image signal processor 126 to the image signal 208 include, but are not limited to, basic color correction, auto white balance, auto exposure, focus, noise reduction, black level, lighting, demosaicing, contrast (e.g. distribution), gamma value adjustment, and image sharpening, to name just a few. In one or more implementations, each transformation corresponds to a respective transformation algorithm 212. Alternatively, or additionally, multiple transformations are implemented by a single such transformation algorithm 212.

In the illustrated example, the image signal processor 126 includes processing blocks 214. In one or more implementations, each processing block 214 is configured to apply one or more of the transformations to the image signal 208. For example, a processing block 214 is configured to apply the transformations of a respective transformation algorithm 212. Alternatively or additionally, each processing block 214 is configured to apply a respective transformation and is controlled (e.g., enabled or disabled) according the transformation algorithm. In other words, a transformation algorithm 212 controls which of the processing blocks 214 are utilized to apply respective transformations to the image signal 208. By way of example, one of the processing blocks 214 may be configured to perform basic color correction, a different one of the processing blocks 214 may be configured to perform noise reduction, and so on, such that the transformation algorithm 212 can enable and disable different processing blocks 214 of the image signal processor 126 to apply different combinations of transformations at different times, such as a different combination when the computing device runs on battery power and when the computing device is plugged in and running on power from an external source, e.g., AC power.

In accordance with the described techniques, based on a power state of the battery 125, the system on chip 202 controls the image signal processor 126 to apply transformations selectively to the image signal 208 to produce the video data 210. For example, the image signal processor 126 is controlled to apply transformations selectively when a computing device runs on power from the battery 125 and/or when the battery 125 is determined to have an amount of power which satisfies a threshold, e.g., less than or equal to a threshold amount. In one or more implementations, the image signal processor 126 is controlled to apply the image transformations selectively at frame boundaries, such that the transformations can be enabled or disabled (e.g., individually or collectively) on a frame-by-frame basis.

In at least one example, a subset of one or more transformations is applied by the image signal processor 126 based on a power state of the battery 125. Alternatively, or additionally, the image signal processor 126 is controlled to apply image transformations at a throttled frequency based on a power state of the battery 125. For instance, the image signal processor 126 is controlled to apply enabled image transformations at a lower frame rate (e.g., five frame per second (FPS)) when the device runs on power from the battery 125 and/or when an amount of power of the battery 125 is less than or equal to a threshold amount. Said another way, the image signal processor 126 is controlled to operate at a lower frequency (e.g., 5 FPS) when the power of the battery 125 is less than a threshold amount as compared to a higher frequency, such as a default or normal frame rate (e.g., 30 or 60 FPS), when the power of the battery 125 is greater than the threshold amount. Additionally, to “operate” the image signal processor 126 can include applying different sets of image transformations in the two different scenarios, such as a limited set of image transformations when the image signal processor 126 operates at the lower frequency (e.g., 5 FPS) and a set with more of the image transformations (e.g., all of them) when the image signal processor 126 operates at the higher frequency (e.g., 30 or 60 FPS). Further, at the lower frequency, this means that the image signal processor 126 operates at the lower frequency, processing and outputting only the lower number of frames per time interval (e.g., 5 FPS). This does not mean that the image signal processor 126 continues to operate at the higher frequency (e.g., the normal or default rate of 30 or 60 FPS) and only apply the limited transformations at the lower frequency (e.g., 5 FPS), resulting in an output where 5 of 30 frames have the limited subset of images transformations applied and 25 of the 30 frames have more of the image transformations applied (e.g., all of them).

When the device is plugged in and running on external power and/or when an amount of power of the battery 125 is greater than or equal to a threshold amount, the image signal processor 126 may be controlled to apply enabled image transformations (e.g., all of them) at a higher rate. The selective application of image transformations by the image signal processor 126, such as while running on power from the battery 125 (e.g., only on battery power), contrasts with scenarios where the computing device runs on external power and/or scenarios where the battery charge level of the battery is equal to or exceeds a threshold amount of power. When running on external power or the battery still has enough power, for instance, the image signal processor 126 may apply more of the image transformations (e.g., all of them) and/or apply transformations at a higher frequency, e.g., 30 or 60 frames per second (FPS).

As mentioned above, the system on chip 202 selectively controls which transformations the image signal processor 126 applies to the incoming image signal 208 to produce the video data 210. In one or more implementations, the system on chip 202 controls which transformations are applied by enabling and disabling (e.g., activating and deactivating) different processing blocks 214 of the image signal processor 126. To enable basic color correction and noise reduction only, for instance, the system on chip 202, enables the processing blocks 214 which correspond to those transformations and disables the other processing blocks 214. Thus, the system on chip 202 enables the respective processing blocks 214 of the image signal processor 126 for the transformations that are to be applied. The image signal processor 126 then processes the image signal 208 using the activated processing blocks 214 to produce the video data 210 with the respective transformations.

While the described system is capable of enabling and disabling any of the transformations selectively (e.g., by enabling and disabling processing blocks 214 selectively), some transformations are more vital than others for outputting video data that looks as a human expects the video to look. In one or more implementations, for example, the system on chip 202 controls the image signal processor 126 to apply at least one of basic color correction, auto white balance, and auto exposure to the image signal 208, while disabling at least one other image transformation and/or applying the at least one other image transformation to a lesser degree. This is because one or more of basic color correction, auto white balance, and auto exposure may be paramount to producing an image or video data that looks as expected by a human. In at least one implementation, the transformations enabled and/or a frequency at which the image signal processor 126 applies transformations are based on an application for which the video data 210 is used. For instance, the transformations enabled and/or the frequency of output may be different for use during a video conferencing call than for use by a vehicle, such as to perform one or more autonomous driving tasks.

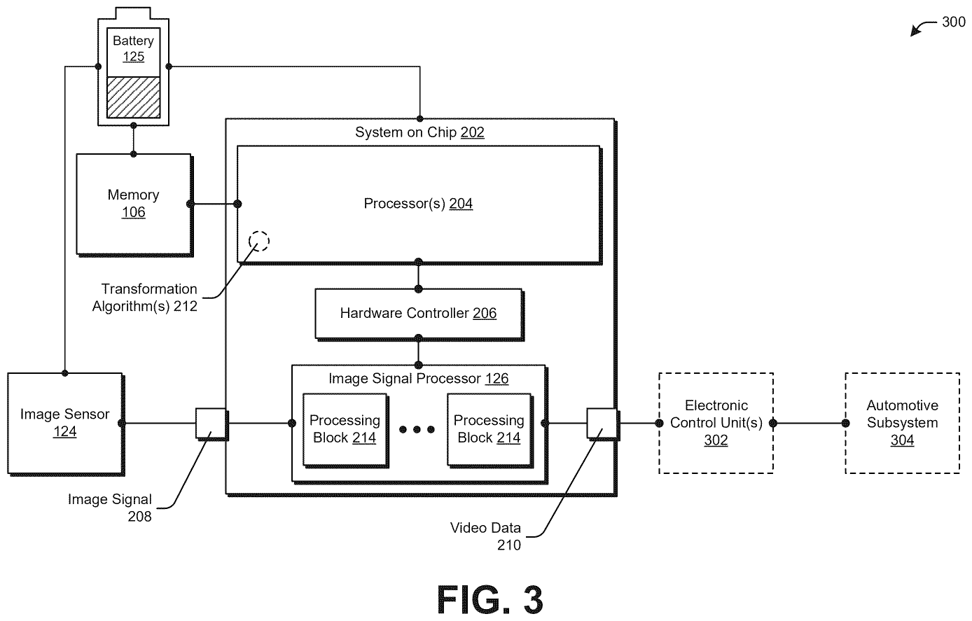

The image signal processor 126 is configured to output the video data 210 to a video destination. In the context of FIG. 2, the image signal processor 126 is depicted outputting the video data 210 to a video encoder 216. It is to be appreciated that in variations the image signal processor 126 outputs the video data 210 to any of a variety of other destinations, such as to the memory 106, a different type of storage device, one or more components of a vehicle as depicted in the example of FIG. 3, and so on.

In some implementations, the video data 210 output by the image signal processor 126 may be encoded by the video encoder 216 before being displayed on the display 130. Video encoding is a process of compressing and converting video data into a format that is more suitable for transmission or storage. This compression may reduce the amount of data needed to represent the video, which can be beneficial for efficient storage and transmission, particularly in scenarios where bandwidth or storage capacity may be limited.

The video encoder 216 may employ various encoding techniques to compress the video data 210. Some examples of video encoding formats include H.264/AVC (Advanced Video Coding), H.265/HEVC (High Efficiency Video Coding), VP9, and AV1. These encoding formats may use different algorithms and techniques to achieve compression, such as motion estimation, transform coding, and entropy coding.

After the video data 210 is encoded by the video encoder 216, the resulting encoded video data 218 may be provided to the display 130 for presentation to the user. The display 130 may include hardware or software components capable of decoding the encoded video data 218 back into a format suitable for display. In some cases, this decoding process may be performed by a separate video decoder component, or it may be integrated into the display hardware itself. The decoded video data may then be rendered on the display 130, allowing the user to view the processed and encoded video content.

In a scenario where the system described in FIG. 2 is included in a device such as a laptop or mobile phone running on battery power during a video conferencing call, the dynamic power optimization techniques may provide significant advantages. As the device operates solely on battery power, the system on chip 202 may adjust the frequency at which the image signal processor 126 processes the image signal 208 to produce frames of video data 210. This adjustment may be based on the current power state of the battery 125, allowing the device to balance video quality with power consumption.

For instance, when the battery power drops below a certain threshold, the system on chip 202 may instruct the image signal processor 126 to reduce its processing frequency from a higher rate (e.g., 30 or 60 FPS) to a lower rate (e.g., 5 FPS). Additionally, the system may selectively enable or disable certain image transformations performed by the processing blocks 214. In this use case, the system may prioritize transformations that are most important for video conferencing, such as basic color correction, auto white balance, and auto exposure, while disabling or reducing the intensity of other, less critical transformations like advanced noise reduction or sharpening.

These optimizations may allow the device to significantly extend its battery life during the video conferencing call, which may be particularly beneficial for users who need to participate in long meetings or who may not have immediate access to a power source. The reduced processing load may also help prevent the device from overheating during extended use, which can be a common issue with laptops and mobile phones during video calls. Despite the reduced processing, the system may still maintain a level of video quality that is acceptable for video conferencing, as the most essential image transformations are preserved.

Furthermore, the system may dynamically adjust its optimization strategy based on real-time changes in the battery's power state or the specific requirements of the video conferencing application in use. For example, if the user switches from a one-on-one call to a group call where their video is displayed in a smaller window, the system may further reduce the processing requirements without significantly impacting the perceived video quality. This adaptive approach may ensure that the device can sustain longer periods of video conferencing while operating on battery power, enhancing the overall user experience and productivity.

In some implementations, the system may be utilized in connection with capturing and previewing still images on a mobile device. When a user opens a camera application on their mobile device, the image sensor 124 may begin capturing light from a scene to produce image signals 208, which are then processed by the image signal processor 126 to produce video data 210 for display as a live preview on the device's display 130. During this preview phase, the system on chip 202 may control the image signal processor 126 to apply a reduced set of transformations or apply transformations at a lower frequency to conserve battery power. This may result in a preview image that is of slightly lower quality but is sufficient for framing and composition purposes while maximizing battery life.

When the user indicates they are ready to capture a still image, such as by pressing a capture button, the system may temporarily adjust its processing parameters. In this case, the system on chip 202 may instruct the image signal processor 126 to apply a full set of image transformations or increase the processing frequency to produce a higher quality image. This approach allows the system to capture a high-quality still image while maintaining power efficiency during the preview phase. After the image is captured, the system may revert to the power-saving mode for preview display until the user exits the camera application or initiates another capture. This dynamic adjustment between preview and capture modes may help balance image quality and power consumption, potentially extending the device's battery life during photography sessions.

FIG. 3 is a block diagram of a non-limiting example 300 in which a system provides dynamic power optimization for image signal processing for use with a vehicle. The system includes components similar to those described in FIG. 2, such as the battery 125, system memory 106, system on chip 202, processor(s) 204, and image signal processor 126. However, this configuration is adapted for use in automotive applications.

In this automotive context, the image sensor 124 may be one of several cameras positioned around the vehicle to capture various views of the surrounding environment. The image signal 208 from these cameras is processed by the image signal processor 126, which may apply specific transformations suitable for autonomous driving tasks.

The video data 210 produced by the image signal processor 126 is provided to an electronic control unit (ECU) 302. This ECU 302 may be responsible for interpreting the processed video data and making decisions related to vehicle operation. The ECU 302 can interface with various automotive subsystems 304, such as steering, braking, or navigation systems, to control the vehicle based on the processed video data.

In the automotive context, the power optimization techniques may be applied differently compared to mobile devices. For instance, while the vehicle is in operation, the system may prioritize maintaining a consistent frame rate and enabling all relevant image transformations to ensure reliable operation of autonomous driving features. However, when the vehicle is parked or in a low-power state, the system may reduce the frequency of image processing or disable certain transformations to conserve battery power. In at least one implementation, for instance, the frequency at which the image signal processor 126 is controlled to process the image signal 208 is higher when the vehicle is in motion than when the vehicle is stationary (e.g., parked). By way of example and not limitation, the frequency while the vehicle is in motion may correspond to a frame rate of 60 frames per second (or higher) whereas the frequency while the vehicle is stationary may correspond to a frame rate of five frames per second (or some other number of frames per unit of time that is less than the in-motion frequency). This higher frequency enables the ECU 302 to make decisions for controlling the vehicle faster than with video data produced at the lower frequency.

The processor(s) 204 may dynamically adjust the operation of the image signal processor 126 based on various factors such as vehicle speed, time of day, or detected objects in the environment. This adaptive approach allows the system to balance power consumption with the requirements of safe and effective autonomous driving operations.

In the automotive context, the described system may offer several advantages. The ability to dynamically adjust image processing based on the vehicle's operational state can help optimize power consumption without compromising safety-critical functions. For example, when the vehicle is stationary or in low-speed urban environments, the system may reduce the processing frequency or disable certain non-essential transformations to conserve energy. Conversely, during high-speed highway driving or complex traffic scenarios, the system may increase the processing frequency and enable additional image transformations to enhance object detection and recognition capabilities. This adaptive approach may also extend to different lighting conditions, adjusting image processing parameters to ensure optimal visibility during daytime, nighttime, or adverse weather conditions. Additionally, the system's flexibility may allow for easy integration with various automotive sensor suites, potentially improving overall system efficiency and reducing hardware costs.

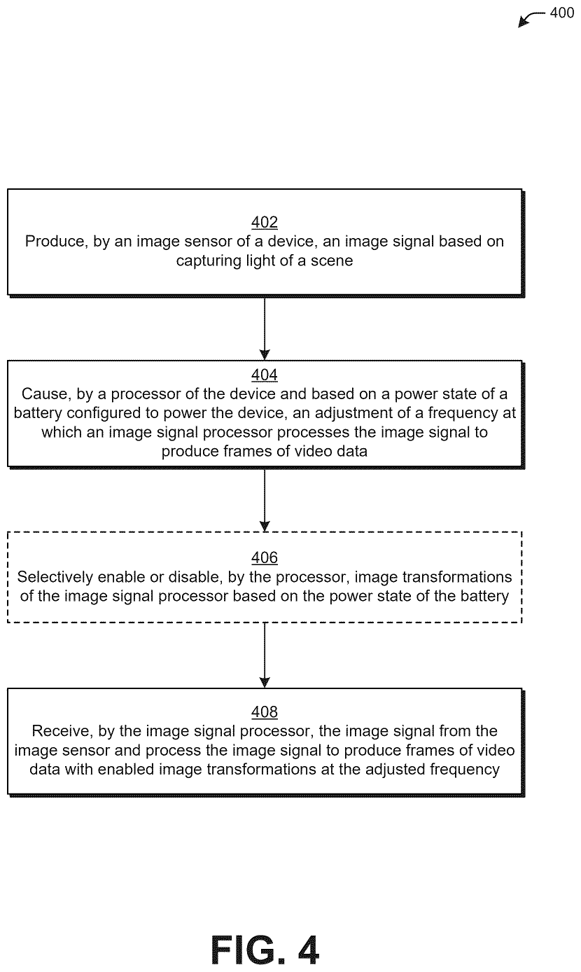

FIG. 4 depicts a procedure 400 in an example implementation of dynamic power optimization for image signal processing.

An image signal is produced by an image sensor of a device based on capturing light of a scene (block 402). By way of example, the image sensor 124 is a component of a camera of a device which includes a system similar to the systems depicted in FIGS. 2 and 3, and the image sensor 124 captures light of a scene to produce the image signal 208. The output of an image sensor may be a raw analog signal representing the intensity of light captured by individual photosensitive elements of the sensor. This raw signal may then be converted to a digital format, resulting in an unprocessed digital image that contains information about color and brightness for each pixel, which can be further processed by subsequent components in the imaging pipeline.

A processor of the device causes an adjustment of a frequency at which an image signal processor processes the image signal to produce frames of video data, and the adjustment is based on a power state of a battery configured to power the device (block 404). For example, the processor(s) 204 of the system on chip 202 may adjust how frequently the image signal processor 126 processes the image signal 208 based on the current charge level or power output capabilities of the battery 125. For example, the processor(s) 126 may reduce the frequency when a charge level of the batter is below a threshold. The power state of the battery 125 can be determined through various methods and metrics. The system on chip 202 may periodically query a battery management system and/or the operating system 104 to obtain charge level information, assess voltage levels or power delivery capabilities, monitor overall power consumption patterns, consider external factors like power source connections, and take into account user-selected or defined power modes or settings. In automotive applications, the power state assessment may include factors specific to the vehicle's electrical system. By continuously evaluating these aspects, the system on chip 202 can make informed decisions about adjusting image processing tasks to balance performance and power conservation.

The processor selectively enables or disables image transformations of the image signal processor based on the power state of the battery (block 406). For example, the processor(s) 204 may enable or disable specific processing blocks 214 within the image signal processor 126 depending on the current power state of the battery 125. When the battery charge level is below a threshold, for instance, the processor(s) 204 may disable one or more image transformations. In one or more implementations, the image transformations applied by the image signal processor 126 based on the power state of the battery 125 can be enabled or disabled at a frame boundary, such that transformations are controlled on a frame-by-frame basis. This selective enabling or disabling of image transformations allows for power conservation when the battery charge is low.

The image signal processor receives the image signal from the image sensor and processes the image signal to produce frames of video data with enabled image transformations at the adjusted frequency (step 408). By way of example, the image signal processor 126 receives the image signal 208 from the image sensor 124 and applies the enabled transformations at the frequency determined in block 404 to generate the video data 210.

A number of implementations have been described. Nevertheless, it will be understood that various modifications may be made without departing from the spirit and scope of the disclosure. Accordingly, other implementations are within the scope of the following claims.

What is claimed is:

1. A computing device comprising:
an image signal processor configured to process image signals received from an image sensor; and
a processor coupled to the image signal processor, the processor configured to cause an adjustment of a frequency at which the image signal processor processes the image signals based on a power state of the computing device.

2. The computing device of claim 1, wherein the processor is further configured to control the image signal processor to selectively apply image transformations to the image signals based on the power state of the computing device.

3. The computing device of claim 2, wherein the power state of the computing device is based on a battery charge level of a battery of the computing device.

4. The computing device of claim 3, wherein the processor is further configured to dynamically adjust the frequency and the image transformations applied by the image signal processor based on real-time changes to the battery charge level of the battery.

5. The computing device of claim 2, wherein the processor is configured to control the image signal processor to selectively apply the image transformations by selectively enabling or disabling the image transformations applied to the image signals.

6. The computing device of claim 5, wherein the image transformations selectively enabled include at least one of basic color correction, auto white balance, auto exposure, focus, noise reduction, black level lighting, demosaicing, contrast gamma value adjustment, or image sharpening.

7. The computing device of claim 5, wherein the image transformations selectively disabled include at least one of basic color correction, auto white balance, auto exposure, focus, noise reduction, black level lighting, demosaicing, contrast gamma value adjustment, or image sharpening.

8. The computing device of claim 1, wherein the processor is configured to cause a reduction of the frequency at which the image signal processor operates to conserve battery power, responsive to a battery charge level of a battery being below a threshold.

9. The computing device of claim 1, wherein the power state of the computing device is determined based on one or more of: a battery charge level of a battery of the computing device, a power source connection status, or a user-selected power mode.

10. The computing device of claim 1, wherein the processor is further configured to cause the adjustment of the frequency at which the image signal processor processes the image signals based on an application for which video data produced by the image signal processor is used.

11. The computing device of claim 1, wherein the image signal processor includes multiple processing blocks, each processing block configured to apply one or more image transformations, and wherein the processor is configured to selectively enable or disable each of the multiple processing blocks based on the power state of the computing device.

12. The computing device of claim 1, wherein the computing device comprises a laptop.

13. A computer-implemented method comprising:
producing, by an image sensor of a device, an image signal based on capturing light of a scene;
causing, by a processor of the device and based on a power state of a battery configured to power the device, adjustment of a frequency at which an image signal processor processes the image signal to produce frames of video data;
selectively enabling or disabling, by the processor, image transformations of the image signal processor based on the power state of the battery; and
receiving, by the image signal processor, the image signal from the image sensor and processing the image signal to produce the frames of video data with the enabled image transformations at the frequency.

14. The computer-implemented method of claim 13, wherein the power state of the battery corresponds to a battery charge level of the battery.

15. The computer-implemented method of claim 14, wherein causing the adjustment of the frequency at which the image signal processor processes the image signal comprises reducing the frequency when the battery charge level of the battery is below a threshold.

16. The computer-implemented method of claim 14, wherein the selectively enabling or disabling the image transformation further comprises disabling one or more image transformations when the battery charge level of the battery is below a threshold.

17. A system comprising:
a battery;
an image sensor configured to output image signals; and
an image signal processor coupled to the image sensor and configured to process the image signals based on a power state of the battery.

18. The system of claim 17, wherein:
the system comprises a vehicle and the vehicle further comprises an electronic control unit;
the image signal processor is further configured to output video data based on processing the image signals; and
the electronic control unit is configured to interface with one or more subsystems of the vehicle to control operation of the vehicle based on the video data.

19. The system of claim 18, wherein the image signal processor is further configured to process the image signals at a frequency based on the operation of the vehicle.

20. The system of claim 19, wherein the frequency is higher while the vehicle is in motion and the frequency is lower while the vehicle is stationary.
